(19) United States
(12) Patent Application Publication
(10) Pub. No.: US 2018/0116135 A1
(43) Pub. Date: May 3, 2018

(54) IRRIGATION DEVICE

(71) Applicant: Fiskars Brands, Inc., Middleton, WI (US)

(72) Inventors: Andrew P. Block, Madison, WI (US); Nick Vallo, Madison, WI (US)

(73) Assignee: Fiskars Brands, Inc., Middleton, WI (US)

(21) Appl. No.: 15/338,213

(22) Filed: Oct. 28, 2016

(51) Int. Cl. A01G 25/16; A01G 25/02; B05B 3/04

(52) U.S. Cl. CPC A01G 25/165; B05B 3/0477; B05B 3/0481; A01G 25/02

(57) ABSTRACT

An impact sprinkler is provided. The impact sprinkler includes a stem; a first trip collar rotatably coupled to the stem, the first trip collar including a first trip flange; a second trip collar rotatably coupled to the stem, the second trip collar including a second trip flange; a nozzle body including a spray nozzle structured to emit a fluid stream, the nozzle body rotatably coupled to the stem; and a base coupled to an end of the stem opposite an end of the stem where the first and second trip collars are positioned such that the nozzle body is an intermediary between the base and the first and second trip collars.

### FIELD

The present disclosure relates to irrigation devices. More particularly, the present disclosure relates to a rotation limitation mechanism for an impact/impulse sprinkler.

### BACKGROUND

This section is intended to provide a background or context to the disclosure recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

Irrigation devices, such as sprinklers, are used to provide fluid such as water to desired areas typically without user control. Beneficially, this enables owners/users of the irrigation devices to tend to other tasks while fluid is being provided to a desired area (e.g., a region of a lawn, a flower bed, etc.). There are many types of irrigation devices: a pop-up sprinkler that is stored at or below a ground surface that selectively “pops-up” when in use to provide fluid; impact or impulse sprinklers that utilize fluid flow to drive rotation of the spray nozzle of the sprinkler; fixed spray sprinklers that provide a fixed stream of fluid (e.g., no rotation or other movement); and various other types of irrigation devices.

Impact or impulse sprinklers are a popular choice for residential (e.g., home lawns) and commercial (e.g., golf courses) uses. In operation, the impact sprinkler is inserted or rested upon a ground surface, coupled to a fluid source, and activated to provide a stream of fluid in a rotatable manner. One popular aspect of an impact sprinkler is the inclusion of a rotation limitation mechanism. The rotation limitation mechanism constrains how far the spray nozzle may rotate (e.g., ten degrees, thirty degrees, etc.), such that the range of rotation provided by the sprinkler may match the desired area for wetting. However, the rotation limitation mechanisms utilized by conventional impact sprinklers are typically fallible (e.g., consisting of only a spring with two stops/projections that limit the rotation of the nozzle, which are prone to loosening or otherwise failing), complicated to use (e.g., disposed in small areas where a user must contort their hand to reach and use), and various other shortcomings.

### SUMMARY

One embodiment relates to a rotation limitation mechanism for an impact sprinkler. The rotation limitation mechanism includes a nozzle body including a first protrusion, a second protrusion, and a spray nozzle structured to emit a fluid stream; a first trip collar including a first trip flange; a second trip collar including a second trip flange; and a trip paddle including a first arm and a second arm, wherein the first arm is structured to selectively engage with each of the first and second trip flanges while the second arm is structured to selectively engage with each of the first and second protrusions to control a rotational amount and a rotational direction of the nozzle body about a first axis.

Another embodiment relates to an impact sprinkler. The impact sprinkler includes a stem; a nozzle body including a spray nozzle structured to emit a fluid stream, the nozzle body rotatably coupled to the stem about a first axis; a swing arm collar rotatably coupled to the stem about the first axis; a swing arm rotatably coupled to the swing arm collar, wherein the swing arm is rotatable about a second axis; a first trip flange rotatably coupled to the stem about the first axis; a second trip flange rotatably coupled to the stem about the first axis; and, a trip paddle rotatably coupled to the swing arm collar, wherein the trip paddle is rotatable about a third axis to selectively engage with one of the first and second trip flanges at a time to control a rotational direction of the nozzle body about the first axis. According to one configuration, the first, second, and third axes are each different.

Still another embodiment relates to an impact sprinkler. The impact sprinkler includes a nozzle body including a spray nozzle structured to emit a fluid, the nozzle body rotatable about a first axis; a swing arm assembly including: a swing arm collar rotatable about the first axis; a swing arm coupled to the swing arm collar, the swing arm rotatable about a second axis; and, a diffuser coupled to the swing arm, the diffuser structured to selectively engage with the emitted fluid to cause the diffuser and swing arm to rotate about each of the first and second axes. The impact sprinkler also includes a first trip flange rotatable about the first axis; a second trip flange rotatable about the first axis; and, a trip paddle rotatably coupled to the swing arm collar, wherein the trip paddle is rotatable about a third axis to selectively engage with one of the first and second trip flanges at a time to control a rotational direction and a rotational amount of the nozzle body about the first axis.

Yet another embodiment relates to an impact sprinkler. The impact sprinkler includes a stem; a first trip collar rotatably coupled to the stem, the first trip collar including a first trip flange; a second trip collar rotatably coupled to the stem, the second trip collar including a second trip flange; a nozzle body including a spray nozzle structured to emit a fluid stream, the nozzle body rotatably coupled to the stem; and a base coupled to an end of the stem opposite an end of the stem where the first and second trip collars are positioned such that the nozzle body is an intermediary between the base and the first and second trip collars.

Still yet another embodiment relates to an impact sprinkler. The impact sprinkler includes a stem including a first stem seal and a second steam seal, wherein the stem defines a fluid passage; a nozzle body including a spray nozzle structured to emit fluid received from the fluid passage, the nozzle body rotatably coupled to the stem by the first and second steam seals; a first trip flange rotatably coupled to the stem; and, a second trip flange rotatably coupled to the stem, wherein the first and second trip flanges are structured to control, at least in part, a rotational direction and a rotational amount of the nozzle body relative to the stem.

Still a further embodiment relates to an impact sprinkler. The impact sprinkler includes a stem including a first stem seal and a second steam seal, wherein the stem defines a fluid passage and a fluid outlet port; a first trip collar rotatably coupled to the stem, the first trip collar including a first trip flange; a second trip collar rotatably coupled to the stem, the second trip collar including a second trip flange; and, a nozzle body including a spray nozzle structured to emit a fluid stream, the nozzle body rotatably coupled to the stem by the first and second stem seals. According to one configuration, the first and second trip collars are distal from the fluid passage, and the fluid outlet port is disposed between the first and second stem seals.

### BRIEF DESCRIPTION OF THE DRAWINGS

FIG. 1 is a perspective view of an irrigation device, shown as an impact sprinkler, with a rotational limitation mechanism, according to an exemplary embodiment.

FIG. 2 is a top perspective view of the impact sprinkler of FIG. 1 with the nozzle body and swing arm assembly removed, according to an exemplary embodiment.

FIG. 3 is front cross-sectional view of the impact sprinkler of FIG. 1 with the swing arm assembly removed, according to an exemplary embodiment.

FIG. 4 is an exploded assembly view of the impact sprinkler of FIG. 1, according to an exemplary embodiment.

FIG. 5 is a bottom view of the swing arm assembly and trip collars of the impact sprinkler of FIG. 1, according to an exemplary embodiment.

FIG. 6 is a top perspective view of the impact sprinkler of FIG. 1 in the in configuration, according to an exemplary embodiment.

FIG. 7 is a top perspective view of the impact sprinkler of FIG. 1 in the out configuration, according to an exemplary embodiment.

FIG. 8 is a front view of the impact sprinkler of FIG. 7, according to an exemplary embodiment.

FIG. 9 is a top perspective view of the impact sprinkler of FIG. 1 in the right configuration, according to an exemplary embodiment.

FIG. 10 is a top perspective view of the impact sprinkler of FIG. 1 in the left configuration, according to an exemplary embodiment.

FIG. 11 is a perspective view of the impact sprinkler of FIG. 1 with the rotational limitation mechanism disengaged, according to an exemplary embodiment.

FIG. 12 is a perspective view of an impact sprinkler with a rotational limitation mechanism and a disengagement mechanism for the rotational limitation mechanism, according to an exemplary embodiment.

FIG. 13 is a perspective view of an impact sprinkler with a rotational limitation mechanism and another disengagement mechanism for the rotational limitation mechanism, according to an exemplary embodiment.

FIG. 14 is a perspective view of an impact sprinkler with a rotational limitation mechanism and still another disengagement mechanism for the rotational limitation mechanism, according to an exemplary embodiment.

### DETAILED DESCRIPTION

Referring to the Figures generally, an irrigation device with a rotation limitation mechanism is shown according to various embodiments herein. According to the present disclosure, the irrigation device is configured as an impact sprinkler that includes a rotational limitation mechanism positioned away or distal from a spray nozzle. The impact sprinkler includes a stem, a nozzle body rotatably coupled to the stem that includes a pair of protrusions and the spray nozzle, a first trip collar having a first trip flange, a second trip collar having a second trip flange, a swing arm collar coupled to a swing arm and a diffuser, and a trip paddle. The trip paddle, pair of protrusions, and trip flanges may form or at least partly form the rotational limitation mechanism (also referred to herein as the rotation limitation mechanism). Prior to use, a user may position the trip flanges a desired distance from each other to control a range of rotation of the spray nozzle. In use (i.e., when fluid is permitted to be ejected from the spray nozzle), fluid emitted from the spray nozzle may impact or contact a first part of the diffuser. This contact causes the diffuser to rotate about the stem in a first rotational direction. Rotation of the diffuser about the stem in the first rotational direction also causes the trip paddle and swing arm collar to rotate in the first rotational direction about the stem. Due to the coupling or engagement of the swing arm collar with the nozzle body (and, consequently, the spray nozzle), rotation of the swing arm collar also causes the nozzle body to rotate about the stem in the first rotational direction. At some point during this first rotational direction movement, the trip paddle may engage with one of the trip flanges. This engagement may cause or eventually cause the trip paddle to move away from that trip flange towards the other trip flange in a direction opposite to the first rotational direction. This action or “trip” then causes the nozzle body to rotate or move a relatively greater amount than the previous discrete amounts of rotation in the first rotational direction. In other words, this trip results in the nozzle body still moving in the first rotational direction, but at a relatively greater amount than the previous discrete amount of rotation in the first rotational direction. As a result, the emitted fluid stream may then impact a second, different part of the diffuser to force, urge, or otherwise push the diffuser in a second, opposite rotational direction relative to the first rotational direction. In turn, the diffuser then moves the swing arm collar in the second rotational direction, which causes the nozzle body to rotate in the second rotational direction. This process may then repeat itself indefinitely to enable the nozzle body to rotate back and forth between the two trip flanges in the first and second rotational directions in order to wet a desired area.

According to the present disclosure, the first and second trip collars (in turn, the trip flanges) are disposed away (i.e., distal) from the spray nozzle. In particular and according to one embodiment, the first and second trip flanges are disposed vertically above the swing arm collar, which is disposed vertically above the spray nozzle. Thus, the trip flanges are positioned away from the spray stream ejected from the spray nozzle. In contrast to conventional impact sprinklers where the trip flanges are positioned below or adjacent the spray nozzle, the orientation of the present disclosure increases an ease of use of the impact sprinkler relative to conventional impact sprinklers. In particular, users may not have to tuck their hands into small areas and now can easily see the range of rotation that the spray nozzle will rotate based on the positioning of the trip flanges. Further, by positioning the trip flanges away or distal from the spray nozzle, the hands of the user may avoid the spray stream emitted from the spray nozzle to avoid getting wet from the spray. This may be an appealing and pleasant feature to the users of the impact sprinkler of the present disclosure.

Beneficially, the impact sprinkler may also include a disengagement mechanism structured to enable a disengagement of the rotational limitation mechanism. Advantageously, some users may desire to have the spray nozzle rotate three hundred and sixty (360) degrees continuously. By including a disengagement mechanism, the spray nozzle is not limited to rotating between the first and second trip flanges. As such, the nozzle body may continuously rotate about the stem in one of the first or second rotational directions. One example of a disengagement mechanism of the present disclosure is that the first and second trip collars are slidable, translatable, or otherwise movable along a primary axis (also referred to herein as the first axis, which is perpendicular or substantially perpendicular to a ground surface when the sprinkler is in use) into positions capable of engaging and not engaging with the trip paddle. Another example of a disengagement mechanism of the present disclosure is rotatable trip flanges that may rotate into positions capable of engaging and not engaging with trip paddle. Still another example of a disengagement mechanism of the present disclosure is a movable trip paddle that may move into and out of positions capable of engaging and not engaging with the trip flanges. These and other disengagement mechanisms are described more fully herein below.

It should be understood that while the present disclosure describes the sprinkler as emitting a “fluid,” this is done on purpose as the present disclosure contemplates that the type of fluid may be highly configurable. For example and in one embodiment, the type of fluid may be water, which may be provided by a spigot or other water source. In another example, a reservoir containing a mixture of water and fertilizer may be used by the sprinkler. In still another example, a variety of other types of fluids may be used. Thus, those of ordinary skill in the art will appreciate and recognize that the irrigation device of the present disclosure may provide water in addition to various other types of fluids with all such variations intended to fall within the scope of the present disclosure.

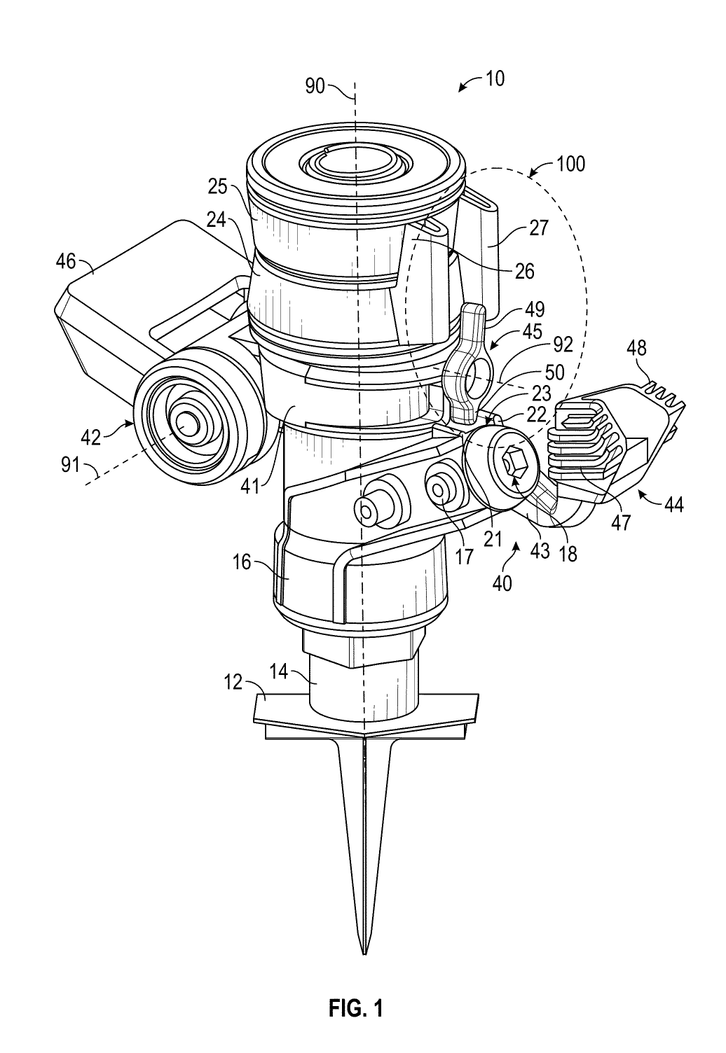

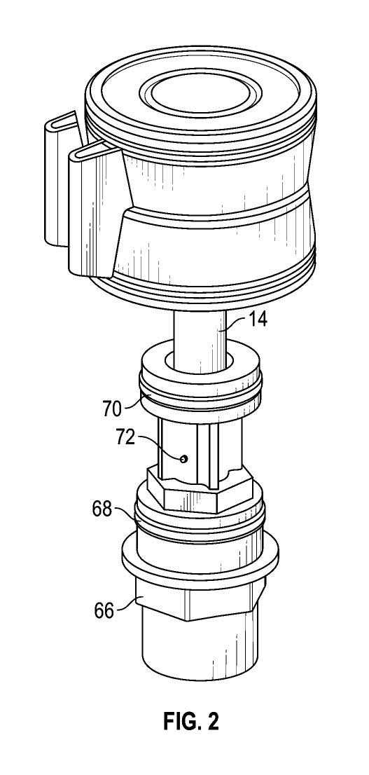

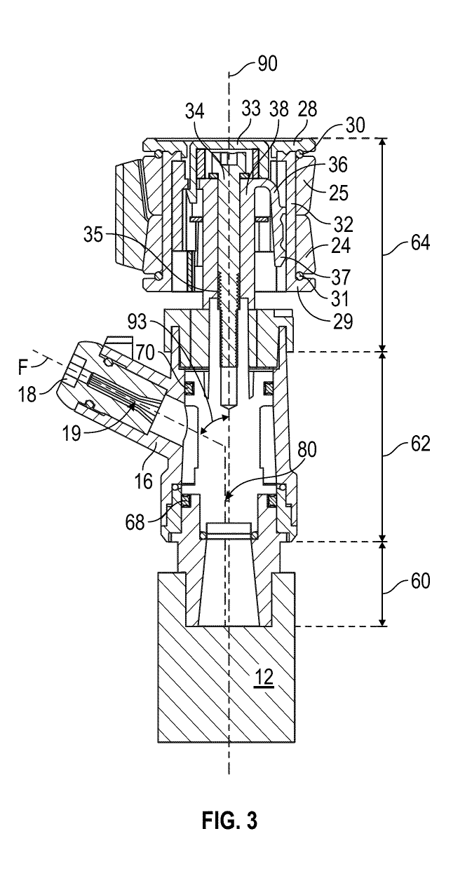

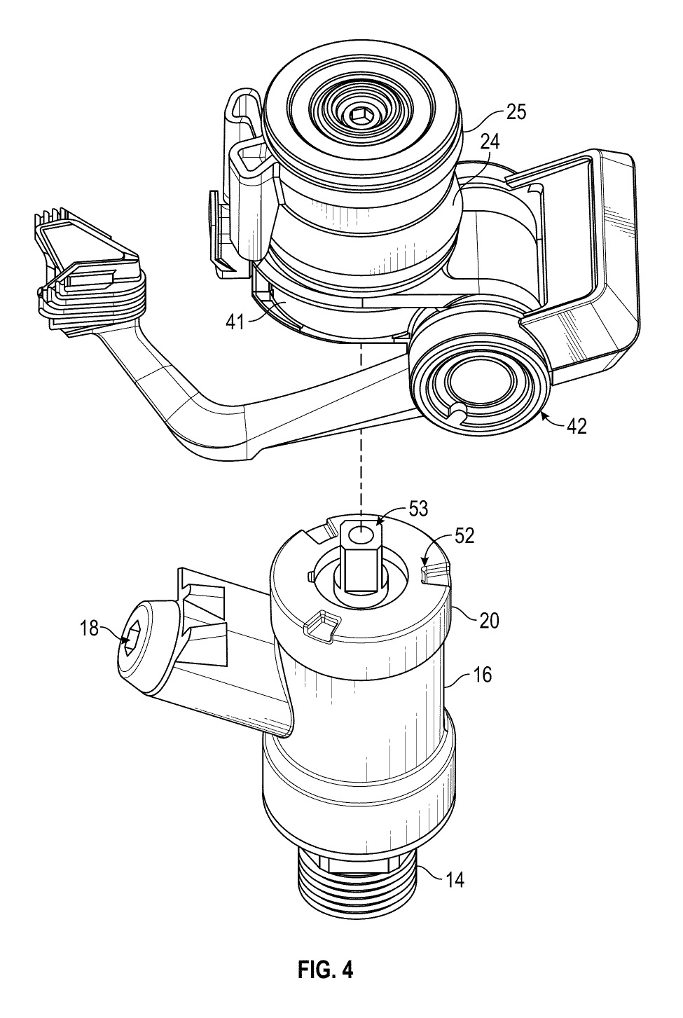

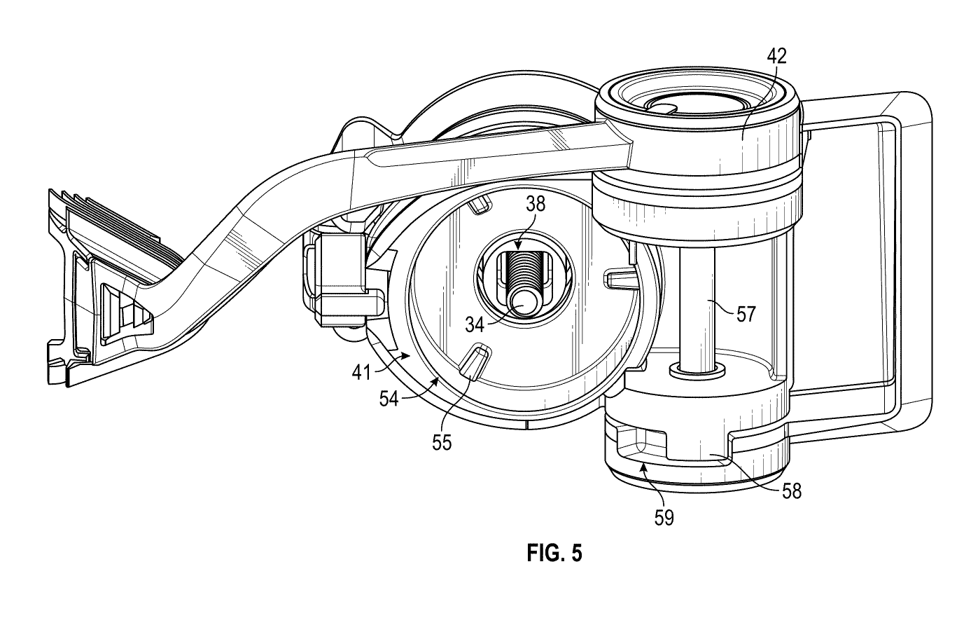

Referring now collectively to FIGS. 1-5, an irrigation device, shown as an impact sprinkler, with a rotational limitation mechanism (also referred to herein as a movement restraining device) is depicted according to an example embodiment. According to the example depicted, the sprinkler 10 is an impact or impulse sprinkler capable of providing a stream of fluid from a spray nozzle. However, it should be understood that the concepts disclosed herein may be applicable with other irrigation devices in addition to an impact sprinkler such that this disclosure is not meant to be limiting. For reference purposes, FIG. 1 depicts the complete sprinkler 10, FIG. 2 depicts the stem and trip collar portion of the sprinkle 10, FIG. 3 depicts a cross-sectional view of the sprinkler 10 of FIG. 2 with some of the components of the sprinkler 10 removed for clarity, FIG. 4 depicts an exploded assembly view of the sprinkler 10 of FIG. 1, and FIG. 5 depicts a bottom view of the spray arm assembly and trip collars of the sprinkler 10 of FIG. 1. As described herein, the rotational limitation mechanism 100 is structured to control a degree of rotation and a direction of rotation of the spray nozzle 18 about a first or primary axis 90. For reference purposes, the primary axis 90 (also referred to herein as the first axis) refers to an axis that may be perpendicular or substantially perpendicular to a ground surface when the sprinkler 10 is upright and in use. In this regard and as shown, the primary axis 90 follows the longitudinal length of the sprinkler 10. In this regard, the primary axis 90 is the axis of rotation for the spray nozzle 18.

With the above in mind, the sprinkler 10 is shown to generally include a base 12 coupled to a stem 14, a nozzle body 16 coupled to the stem 14, first and second trip collars 24 and 25 coupled to the stem 14, a swing arm assembly 40 coupled to the stem 14, and, among other components, a rotation limitation mechanism 100 structured to control the direction and range of rotation of the spray nozzle 18. As shown, the base 12 (e.g., support structure, etc.) is shown as a spiked base. The spike (e.g., point, insertable part, etc.) is shaped to enable insertion into a ground surface, such that any type of shape that facilitates or helps to insert the base 12 may be used. In other embodiments, the base 12 may be structured as a rest-type support structure. The rest-type support structure is characterized by allowing the sprinkler 10 to rest upon a ground surface (e.g., not be inserted into the ground). Thus, the present disclosure is applicable with each type of base 12 configuration. Before turning to the specifics of the rotation limitation mechanism 100, the other components of the sprinkler 10 are firstly described.

The stem 14 is structured as a support structure for the sprinkler 10 such that various components may be coupled thereto. As shown particularly in FIG. 2, the stem 14 is of a substantially-cylindrical shape; however, various other shapes may be utilized that still fall within the scope of the present disclosure (e.g., prism-shaped, rectangular-shaped, etc.). As shown, the stem 14 may be coupled to the first and second trip collars 24 and 25, the nozzle body 16, and the base 12. FIG. 2 depicts the trip collars 24 and 25 coupled to the stem 14 with the nozzle body 16 and base 12 removed to depict the exterior components according to an example embodiment. As shown, the sprinkler 10 generally includes a lower section 60, a middle section 62 positioned vertically above the lower section 60, and an upper section 64 positioned vertically above the middle section 62 (based on the viewpoint in FIG. 3). The lower section 60 is disposed proximate (e.g., close to, near, etc.) the base 12, the middle section 62 is positioned proximate the nozzle body 16 and in particularly the fluid outlet port 72, and the upper section 64 is the area or region above the middle stem section 62. Generally speaking, the upper section 64 corresponds with the components of the sprinkler 10 beginning with the swing arm assembly 40 and vertically above (i.e., the swing arm assembly 40, the trip collars 24 and 25, etc.). The middle section 62 corresponds with the nozzle body 16 and the components included with the area associated with the nozzle body 16 (e.g., the part of the stem 14 that is used to couple to the nozzle body 16, the nozzle body 16 itself, etc.). The lower section 60 corresponds with the remaining portion of the stem 14 that is proximate to but excluding the base 12. In this regard, the sections 60, 62, and 64 are used to denote general regions or areas of the sprinkler 10 where one or a group of components of the sprinkler 10 are disposed or substantially disposed. However and as is clear in the Figures, the aforementioned demarcations of the sections 60, 62, and 64 do not mean that some components may not be a part of multiple sections (e.g., the shaft 34 is shown to extend between the top and middle sections). Thus, the sections 60, 62, and 64 are simply used to refer generally to a group of components for ease of explanation.

As alluded to above, the stem 14 is shown to include various coupling mechanisms for coupling the various components thereto. In particular, the stem 14 includes a first coupling mechanism 66, a second coupling mechanism 68, and a third coupling mechanism 70. The first coupling mechanism 66 may be structured to enable the coupling of the stem 14 to the base 12. The second and third coupling mechanisms 68 and 70 may be structured to enable a coupling of the stem 14 to the nozzle body 16. In the example depicted, the first coupling mechanism 66 includes a hex-bolt surface in combination with a cylindrical outer surface (positioned vertically below the hex-bolt surface, proximate the base 12). In the example of FIGS. 1-2, the cylindrical outer surface is smooth or substantially smooth. As such, the base 12 may have a matching or corresponding surface that enables that portion of the base 12 to slide or translate over the cylindrical outer surface and hex-bolt surface to form an interference fit relationship to securably or relatively securably retain the base 12 to the stem 14. In the example of FIG. 4, the cylindrical outer surface includes a plurality of threads that may engage with threads of the base 12 to couple the base 12 to the stem 14. In still another embodiment, the first coupling mechanism 66 may be disposed about the fluid passage 80, such that the base 12 includes a feature or features that enable internal coupling of the stem 14 to the base 12 (in this instance, “internal” refers to being proximate or close to the fluid passage 80). For example, internal threads may represent the first coupling mechanism 66 that are used to couple the stem 14 to the base 12. In this regard, the base 12 may be inserted up into the stem 14 as compared to being inserted over an exterior surface of the base 12. In yet another embodiment, a combination of internal and external features may be used to couple the stem 14 to the base 12. It should be understood that the aforementioned list of first coupling mechanisms (e.g., interference fit, threads, etc.) is not meant to be limiting as the present disclosure contemplates any type of coupling mechanism that may be used to couple the base 12 to the stem 14.

As mentioned above, the first and second coupling mechanisms 68 and 70 may be structured to couple the stem 14 to the nozzle body 16. As shown, the first coupling mechanism 68 is disposed proximate the trip collars 24 and 25 while the second coupling mechanism 70 is disposed proximate the base 12. In this regard, the first and second coupling mechanisms 68 and 70 are spaced apart relative to each other. As also shown in FIG. 2, the stem 14 may define a fluid outlet port 72 located between the first and second coupling mechanisms 68 and 70. Because fluid may be provided from the fluid passage 80 to the fluid outlet port 72, the first and second coupling mechanisms 68 and 70 may also be used to help fluidly seal the area or region between the fluid outlet port 72 and the nozzle body 16 to avoid fluid escaping at either connection (the first coupling mechanism 68 or at the second coupling mechanism 70). As such, the first and second coupling mechanisms may also be referred to herein as the first stem seal 68 and the second stem seal 70. In this regard, the sprinkler 10 of the present disclosure includes more than one sealing mechanism or seal component. In contrast, current sprinkler technology is attempting to minimize the number of components rather than utilizing more components.

With the above in mind and in the example depicted, the first and second stem seals 68 and 70 are structured as grooves which each may receive a gasket (e.g., an O-ring, a flat washer seal, etc.). Interior surfaces of the nozzle body 16 may engage with the gaskets to rotatably couple the nozzle body 16 to the stem 14 and to provide a fluid tight or substantially fluidly tight seal. In this regard and as shown, the cross-sectional size (e.g., diameter) of where the first groove is positioned (i.e., first coupling mechanism 68) may be relatively larger than that where the second groove is positioned (i.e., the second coupling mechanism 70). As a result, the nozzle body 16 may define an interior shape that corresponds with the size differential provided by the cross-sectional sizes to substantially ensure that the nozzle body 16 is coupled to the stem 14 in the correct manner (i.e., prevent the nozzle body 16 from being coupled to the nozzle body 16 upside down) and to substantially ensure a secure or relatively secure connection between the nozzle body 16 and the stem 14. According to another embodiment, the first and second stem seals 68 and 70 may be structured as threads. According to still another embodiment, the first and second steam seals 68 and 70 may be any type of coupling mechanism (e.g., a bearing or bushing, etc.) that enables the rotatable coupling of the stem 14 to the nozzle body 16. Additionally, sealers or other fluid sealing devices, materials, components, and the like may be used to ensure or substantially ensure a fluid tight seal between the nozzle body 16 and the stem 14. Thus, those of ordinary skill in the art will readily recognize and appreciate the high configurability of the stem seals 68, 70, with all such variations intended to fall within the scope of the present disclosure. Further, it should be understood that any of the aforementioned stem seals may be used alone or in combination with each other to create the rotatable connection between the nozzle body 16 and the stem 14.

As shown in FIG. 3, a fluid passage 80 is defined by the stem 14. In this regard and as shown, the first and second trip collars 24 and 25 are positioned distal or away from the fluid passage 80; in particular and in the example shown, the first and second trip collars 24 and 25 are positioned vertically above the fluid passage 80 when the sprinkler 10 is in use. The fluid passage 80 extends at least part of the length of the stem 14 and is internally disposed within the stem 14. In particular and in this example, the fluid passage 80 (e.g., fluid channel, fluid flow path, etc.) is fluidly coupled to the base 12 (when the base 14 is attached to the stem 14). Accordingly, the base 12 may include a fluid inlet port (not shown) that is used to fluidly couple the sprinkler 10 to a fluid source (e.g., a spigot). In operation, fluid, such as water, flows from the base 12 to the stem 14 via the passage 80 and, eventually, the spray nozzle 18 via the fluid outlet port 72 in order for the sprinkler 10 to provide, emit, or otherwise disperse the fluid. In some embodiments, a filtering element may be included in the fluid passage 80 to filter, screen, or otherwise attempt to remove all or some of the debris in the fluid passing through the fluid passage 80. It should be understood that more than one filter element may be used and the position may be highly configurable (e.g., at or near the fluid outlet port 72, in the nozzle body 16, at or near the fluid inlet port, etc.). Further and while the fluid inlet port is described above as being included with the base 12, in other configurations, the fluid inlet port may be disposed in another position and with a different component. Thus, this description is not meant to be limiting.

Still referring to FIGS. 1-5 and as shown, the nozzle body 16 is disposed away or distal from the first and second trip collars 24 and 25. In particular and in the example shown, the nozzle body 16 is disposed vertically below the first and second trip collars 24 and 25. In this regard and as shown, the nozzle body 16 is disposed about the stem 14 (i.e., surrounds or mostly surrounds the stem 14). Via the first and second coupling mechanisms 68 and 70, the nozzle body 16 is rotatably coupled to the stem 14 about the primary axis 90. As a result, the stem 14 may remain stationary while the nozzle body 16 (or at least various parts thereof) rotates about the stem 14 and primary axis 90.

As also shown, the nozzle body 16 defines a fluid passage 19 that is fluidly coupled to the spray nozzle 18. When the nozzle body 16 is rotatably coupled to the stem 14, the fluid passage 19 (e.g., fluid channel, fluid flow path, etc.) fluidly couples to the fluid passage 80 (i.e., coupled in such a way that fluid is permitted is travel between the components). In this regard, fluid in the fluid passage 80 is provided by the fluid outlet port 72 to the fluid passage 19. Therefore, in use, the nozzle body 16 may rotate about the primary axis 90, such that the spray nozzle 18 may deliver, provide, eject, shoot, or otherwise dispense fluid in an arc or curved pattern. As shown, the spray nozzle 18 is at an angle 93 relative to the primary axis 90. As a result and when the sprinkler 10 is set-up (e.g., put into an operating position), the spray nozzle 18 may provide fluid at or substantially at the angle 93, which is shown to be radially outwards from the primary axis 90. While the angle 93 is highly configurable, in the example shown, the angle 93 is less than ninety (90) degrees relative to the primary axis 90. In another embodiment, the angle 93 may be substantially equal to ninety (90) degrees relative to the primary axis 90. In still another embodiment, a different angle 93 demarcation may be used.

The spray nozzle 18 may have a variety of configurations structured to control the fluid stream provided (e.g., a configuration that enables providing of a jet of fluid, a configuration that enables providing a plurality of jets of fluid, a configuration that enables providing mist, etc.). In some embodiments, a variety of spray nozzles may be sold that are each capable of different fluid stream control devices. As a result, a user may exchange one spray nozzle for another depending on the fluid stream desired.

The nozzle body 16 is shown to include connection points 17 for a fluid flow control device for when the diffuser 45 is not in contact with the jet. The fluid flow control device may be structured as a button, switch, knob, and any other device that may be selectively moved from an ON position to an OFF position. In the OFF position, fluid may be permitted to travel along the flow path 19 in order to be emitted from the nozzle 18. In the ON position, fluid may be prohibited from being emitted from the nozzle 18. Addition of a fluid flow control device may be beneficial for users to selectively control activation of the sprinkler 10 at the sprinkler 10 rather than, for example, at a spigot that is connected to a hose, which is connected to the sprinkler 10. Of course, in other embodiments, the fluid flow control device may be excluded from the sprinkler 10 or disposed with another component of the sprinkler 10.

As also shown, the nozzle body 16 includes a pair of protrusions (e.g., ridges, elevations, edges, raised edges, stop members, walls, etc.) positioned near the trip collars 24 and 25. In particular, the nozzle body 16 includes a first protrusion 21, a second protrusion 22, and a surface 23 interconnecting the first and second protrusions 21 and 22. As shown, the first and second protrusions 21 and 22 extend radially outward from the primary axis 90 as well as in a parallel direction to the primary axis 90 upward (i.e., towards the trip collars 24 and 25) to form walls or abutment structures. As also shown, the first and second protrusions 21 and 22 are disposed adjacent and at least partly above the spray nozzle 18. In the configuration depicted, the surface 23 is structured as a substantially smooth surface (e.g., low friction, etc.) in order to permit/allow a sliding engagement with the trip paddle 45. In this regard and as described more fully herein, the first protrusion 21, second protrusion 22, and surface 23 form a part of the rotation limitation mechanism 100 that limits rotation of the nozzle body 16 and, in turn, the spray nozzle 18.

Referring more particularly to FIG. 4, as shown, the nozzle body 16 also includes a collar 20 that defines a groove 52 (e.g., indent, depression, pit, etc.). The collar 20 is shown to surround the stem 14 and is structured to engage with the swing arm collar 41, which is described in more detail below. As shown, the collar 20 includes three grooves 52 substantially equi-spaced circumferentially about the collar 20. The grooves 52 are structured to engage or mate with protrusions 55 of the swing arm collar 41 to facilitate and enable rotation of the nozzle body 16 when the sprinkler 10 is in use. It should be understood that in other embodiments, the size, shape, number, and relative positioning of the grooves 52 may be different than that depicted in FIG. 4.

Still referring particularly to FIG. 4, another coupling mechanism may be used to couple the stem 14 to the swing arm assembly 40 and the components located vertically above the swing arm assembly 40 (e.g., trip collars 24 and 25, etc.). In the example depicted, this coupling mechanism includes an adapter 53 and a shaft 34. The shaft 34 is described in more detail below. In this regard, the adapter 53 is structured to facilitate or aid coupling of the trip collars 24, 25, and swing arm assembly 40 (and any other components in or substantially in the upper section 64) to the stem 14. The adapter 53 may be included with the collar 20, be included with the stem 14, or be a separate component relative to the nozzle body 16 and/or the stem 14. In any configuration, the adapter 53 may be structured to engage with a corresponding component in the upper section 64. As also shown, the adapter 53 is shown to define an opening that is structured to receive the shaft 34. As a result of the reception of the shape 34 and the size and shape of the adapter 53 relative to a corresponding component in the upper section 64 that engages with the adapter 53 itself, the stem 14 and nozzle body 16 may couple to the swing arm assembly 40 and components located vertically above (e.g., the first and second trip collars 24 and 25). Thus, the adapter 53 represents a coupling mechanism that is utilized to enable rotatable coupling of the first and second trip collars 24, 25 and swing arm assembly 40 to the stem 14 and nozzle body 16.

As alluded to above, the sprinkler 10 is also shown to include a swing arm assembly 40. The swing arm assembly 40 includes a swing arm collar 41 rotatably coupled to the stem 14, a body 42 connected to a swing arm 43, a diffuser 44 coupled to the swing arm 43, and a trip paddle 45 coupled to the swing arm collar 41.

As shown, the swing arm collar 41 has a substantially cylindrical shape. Further, the swing arm collar 41 is structured to rotate about the primary axis 90. In this regard, the swing arm collar 41 may be coupled to the stem 14 in any suitable manner that permits rotation by the swing arm collar 41 relative to the stem 14 (e.g., threads, a protrusion and ridge connection, a bearing or bushing, etc.). In this regard and as shown/mentioned above, rotatable coupling to the stem 14 may be via the adapter 53 and shaft 34 to the stem 14.

The swing arm collar 41 is structured to engage with the nozzle body 16 to cause rotation of the nozzle body 16 when the sprinkler 10 is in use. In this regard and referring particularly to FIG. 5, the swing arm collar 41 is shown to define an opening 54 with a protrusion 55 (in particular, three protrusions 55). The opening 54 may be sized and structured to fit over or substantially over the collar 20. As a result, the protrusions 55 (e.g., ridges, projections, etc.) may engage with the grooves 52. As described herein and as a result of this engagement, the nozzle body 16 may rotate in unison or substantially in unison with the swing arm collar 41 about the primary axis 90 when the sprinkler 10 is in use.

The body 42 may be structured as a housing or other type of support structure for the swing arm 43 and diffuser 44. In the example depicted, the body 42 is coupled to the swing arm collar 41, such that rotation of the swing arm collar 41 causes coincident rotation of the body 42 (i.e., rotation in the same direction). Coupling of the body 42 to the swing arm collar 41 may be via any suitable manner including, but not limited to, fasteners (e.g., bolts, screws, rivets, pins), adhesives (e.g., glue, epoxy, etc.), joining mechanisms (e.g., welding, soldering, etc.), and/or any combination thereof. As shown, the body 42 is substantially cylindrical in shape. Relative to the substantially-cylinder shaped stem 14, however, the body 42 is oriented perpendicular or substantially perpendicular to the stem 14. As a result and as shown, the predominately flat faces of the cylindrical shaped body 42 are positioned on radially opposing sides of the stem 14. It should be understood that in other embodiments, the body 42 may be constructed in a variety of other shapes/sizes (e.g., rectangular, etc.) with all such variations intended to fall within the scope of the present disclosure.

The swing arm 43 is movably coupled to the body 42. In particular, the swing arm 42 is rotatably coupled to one end (at or near) of the body 42. Coupling of the arm 43 to the body 42 may be via any suitable mechanism. For example, a bearing may be used in order to couple the swing arm 43 to the body 42 to permit relative movement between the swing arm 43 and the body 42. As another example, the swing arm 43 may include a pin that is received in a bore of the body 42, where the bore is sized and shape to support the pin and allow the pin to move (e.g., rotate) within the bore. Thus, many different coupling mechanisms may be utilized with all such variations intended to fall within the scope of the present disclosure. The swing arm 43 (e.g., member, wing, etc.) is shown to wrap around yet spaced apart from the stem 14. In this regard, a space or void is created between the swing arm 43 and the stem 14 (and the components coupled to the stem 14 including the nozzle body 14 and the swing arm collar 41). As shown, the swing arm 43 wraps approximately one-hundred eighty (180) degrees around the stem 14. In other embodiments, the swing arm 43 may wrap a different amount around the stem 14.

In the example shown, the swing arm 43 is movable in two directions. First and due to the coupling to the body 42 that is coupled to the swing arm collar 41, the swing arm 43 is rotatable about the primary axis 90. Second, the swing arm 43 is also rotatable about a secondary axis 91. In this regard and as alluded to above, the body 42 may be structured as an enclosure that houses, among other components, a biasing element. The biasing element may bias the arm 43 in the “up position.” The “up position” (also referred to herein as the “first position” or “in configuration” due its placement relative to the fluid emitted from the spray nozzle that enables the diffuser 44 to be “in” contact with the emitted fluid) may be characterized as the swing arm 43 being held at or near the highest rotatable position to the first and second trip collars 24 and 25 (i.e., towards a top of the stem 14, opposite of the base 12). In comparison, a sufficient force may overcome the biasing force to push the arm 43 towards a “down position.” The “down position” (also referred to herein as the “second position” or “out position” due to being out of position from fluid stream) corresponds to the swing arm 43 being rotated into a position proximate to the base 12. In the example depicted, the biasing element is structured as a spring. The spring may be a torsional spring or any other type of spring that is capable of biasing the arm 43 into the up position. However, in another configuration, the body 42 may house a counterweight that biases the swing arm 43 to the in configuration.

According to one embodiment, the amount of rotation of the swing arm 43 and diffuser 44 about the second axis 92 may be controlled by a stop mechanism. With reference to FIG. 5, one example of a stop mechanism is shown. In this regard and as shown, the swing arm 43 is coupled to a shaft 57 (e.g., rod, pole, etc.) rotatably coupled to the body 42. The shaft 57 may be supported by the body 42 in such a way to permit rotation by the shaft 57 (and, in turn, the swing arm 43) relative to the second axis 92. In this regard, the second axis 92 may be coincident with the shaft 57 (i.e., a center axis of the shaft 57 coincides with the second axis 92 such that rotation of the shaft 57 is about or substantially about the second axis 92). As shown, one end of the shaft 57 (in this example, distal from the swing arm 43), is coupled to a disk that includes a protrusion 58. The protrusion 58 is received in a groove 59 defined by the body 42. The protrusion 58 cooperates with the groove 59 to limit the range of rotation of the diffuser 44 about the second axis 92. In this regard, the rotation of the diffuser 44 about the second axis 92 is highly configurable based on the size of the groove 59. It should be understood that in other embodiments, various other types of mechanisms may be utilized to limit or control the rotation amount of the diffuser 44 about the second axis 92 (e.g., springs, other stop-type mechanisms, etc.).

The body 42 may also include a handle 46. The handle 46 may be coupled to the body 42 and extend away therefrom. In the embodiment depicted, the handle 46 extends away from the stem 14. The handle 46 (e.g., lever, etc.) enables a user to manually actuate rotation of the swing arm 43 about the second axis 91. Beneficially, a user may then hold the swing arm 43 (and, in turn, the diffuser 44) in the down position to, e.g., clean the spray nozzle 18, replace the spray nozzle 18, or otherwise increase the unobstructed area to adjust or perform maintenance on the sprinkler 10. Additionally, the user may also rotate the arm 43 about the primary axis 90 as well. Of course, in other embodiments, the handle 46 may be excluded. In still other embodiments, a retainer or retention mechanism may be included with the sprinkler 10 that holds or retains the swing arm 43 and/or diffuser 44 in a desired position. For example, a latch may be disposed on the nozzle body 16 that selectively locks or retains the swing arm 43. In this case, a user may not have to continuously hold the swing arm 43 in the desired down position, but may instead use the latch to hold the arm 43.

As mentioned above, the diffuser 44 is coupled to the swing arm 43. In particular, one end of the swing arm 43 is coupled to the body 42 while another end of the swing arm 43 is coupled to the diffuser 44. The diffuser 44 extends outward and away from the swing arm 43 and generally includes a first set of features 47 and a second set of features 48. In the example depicted, the first and second sets of features 47, 48 are structured as ridges and, in particular, a plurality of parallel or substantially parallel oriented ridges (that is to say, the ridges that form the first set of features 47 are parallel to each other and the ridges that form the second set of features 48 are parallel to each other). Thus, the first and second sets of features 47 and 48 may also be referred to as ridges 47 and ridges 48. As also shown, the diffuser 44 has a substantial V-shape. In this regard, the first set of features 47 is disposed on side of the “V” while the second set of features 48 is disposed on the other side of the V. Such a configuration may enable the pushing of the diffuser to enable rotation of the nozzle body, which is described herein below. Furthermore and as shown, the ridges 47 and 48 are at an upward angle relative to the primary axis 91 (e.g., pointed upward in a direction towards the trip collars 24, 25).

Based on the foregoing, the diffuser 44 is structured to interfere, impede, contact, or otherwise engage with the fluid stream emitted from the spray nozzle 18. In particular and due to the upward orientation of the ridges 47, 48, the fluid stream may impact the ridges 47 or 48 to interfere with the flow of fluid from the nozzle 18 to push or otherwise direct the fluid upward. Further, Applicant has determined that the interference with the ridges may also impart a rotational force onto the fluid stream. The rotational force may cause the fluid stream to curve or rotate rather than being emitted in a substantially straight line or direction.

It should be understood that in other embodiments, the diffuser 44 may have a different structure, different features, different shapes, different size, and/or some combination therewith. For example, the ridges may be removed such that each surface of the V-shaped diffuser is predominately flat or smooth. As another example, the V-shape of the diffuser may be replaced with a variety of other shapes, such as a door on a hinge that rotates upon an impact with the fluid stream, etc. Thus, those of ordinary skill in the art will readily recognize and appreciate the high configurability of the structure of the diffuser 44.

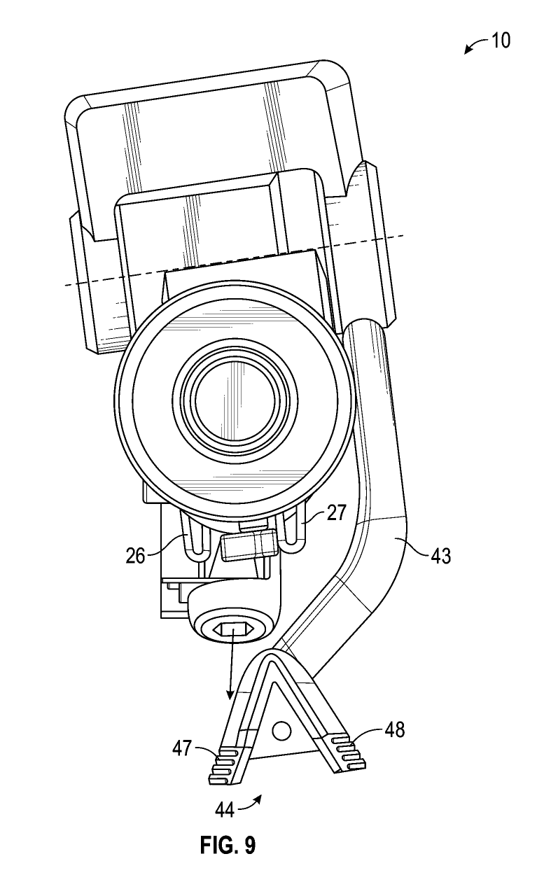

The trip paddle 45 may be rotatably coupled to the swing arm collar 41. As part of the rotation limitation mechanism 100, the trip paddle 45 (e.g., toggle device, etc.) is structured to aid limiting rotation of the nozzle body 16 and cause, at least in part, a change of rotational direction of the nozzle body 16 about the primary axis 90. As shown, the trip paddle 45 is disposed on the swing arm collar 41 proximate to the protrusions of the nozzle body 16. As shown and generally speaking, the trip paddle 45 includes a first arm 49 and a second arm 50. The first arm 49 (e.g., flap, member, paddle, extension, etc.) extends outward and away from the second arm 50 (e.g., flap, member, paddle, extension, etc.) in a substantially opposite direction. In particular, the first arm 49 is oriented or directed upward (e.g., towards the trip collars 24 and 25) while the second arm 50 is oriented in a direction downward (e.g., towards the base 12 or nozzle body 16. A coupling mechanism 51 (see FIG. 9) is used to rotatably couple the trip paddle 45 to the swing arm collar 41. The coupling mechanism 51 may be any type of coupling mechanism (e.g., a fastener such as a screw, a pin, an axle and hub assembly, etc.) that permits relative rotation between the trip paddle 45 and the swing arm collar 41 about a third axis 92. The coupling mechanism 51 may also include a biasing member, such as a spring, that forces or drives rotation of the trip paddle 45. As shown, the third axis 92 is perpendicular or substantially perpendicular relative to the first axis 91. Thus, when the sprinkler 10 is placed or inserted into a ground surface, the third axis 92 may be substantially parallel to the ground surface.

In operation, the first and second arms 49, 50 rotate about the third axis 92. In particular and as explained more fully herein below, the first arm 49 may selectively engage or contact one of the trip flanges 26 or 27 while the second arm 50 may selectively engage or contact one of the protrusions 21 or 22. As a result of these engagements, the nozzle body 16 may rotate about the primary axis 90 and reverse rotational directions about the primary axis 90.

Thus, and as shown, the sprinkler 10 includes components that have three rotational degrees of freedoms. The swing arm 43 (and diffuser 44) rotates about the second axis 91; the swing arm (and diffuser 44) also rotates about the first axis 90; and, the trip paddle 45 rotates about the third axis 93. Further and in the example shown, each of the axes is different relative to each other. Beneficially, the use of different axes may prevent unwanted interaction between the components to ensure or substantially ensure seamless operation of the sprinkler 10.

Still referring to FIGS. 1-5, and as mentioned herein, the sprinkler 10 includes a first trip collar 24 and a second trip collar 25. The first trip collar 24 is positioned vertically below the second trip collar 25, such that first trip collar 24 is closer to the base 12 than the second trip collar 25. The first and second trip collars 24, 25 (e.g., rings, etc.) are coupled to the stem 14 above the first and second stem seals 68 and 70. Further, the first and second trip collars 24, 25 are also structured to be rotatable relative to each other and relative to the stem 14.

In this regard and referring more particularly to FIG. 3, each of the first and second trip collars 24, 25 may be rotatably coupled to the stem 14 by a variety of mechanisms. Similar to the coupling mechanisms 66, 68, and 70, any type of coupling mechanism may be used to couple the trip collars 24, 25 to the stem 14. For example, threads disposed on each of the stem 14 and the first and second collars 24, 25 may be used to couple the trip collars 24, 25 to the stem 14. In another example, a protrusion on each of the collars 24, 25 may engage with ridges of the stem 14 to enable coupling. Thus, as those of ordinary skill in the art will recognize and appreciate, a variety of coupling mechanisms that may be used to couple the first and second trip collars 24, 25 to the stem 14 with all such possibilities intended to fall within the scope of the present disclosure.

In the example of FIGS. 1-5, an intermediary collar 32 (e.g., ring, etc.) is disposed radially as intermediary between the first and second trip collars 24, 25 and a collar 38. The trip collars 24 and 25 then surround or substantially surround the intermediary collar 32. As a result, a bearing or bushing type relationship may be created or formed. In this regard and while a tight or interference type relationship is formed between the intermediary collar 32 and the trip collars 24, 25, the benefit is that relative rotation of the collars 24, 25 may require a force provided by a user. Thus, the collars 24 and 25 may not move on their own, which may ensure correct operation of the sprinkler 10. As also shown and alluded to above, an outer cap 28 is disposed proximate the second collar 25 while the intermediary collar 32 includes a ledge 29 (e.g., shoulder, protrusion, etc.) disposed proximate the first trip collar 24. A top seal member 30 (e.g., gasket, O-ring, etc.) is then disposed between the cap 28 and the second trip collar 25 while a bottom seal member 31 (e.g., gasket, O-ring, etc.) is then disposed between the ledge 29 and the first trip collar 24. The top seal member 30 and bottom seal members 31 may be used to provide additional friction between the intermediary collar 32 and the first and second trip collars 24 and 25.

The collar 38 (e.g., support structure, etc.) may couple to and at least partially support the components extending radially outward from the collar 38. In this regard and as shown, the collar 38 includes a hook 36 extending outward from a remaining portion of the collar 38. With reference to FIG. 5, the collar 38 also defines the matching or corresponding component that mates or engages with the adapter 53 itself to aid coupling of the collar 38 (and the components coupled thereto) to the adapter 53 (and the components coupled thereto). Further and as shown, the collar 38 may include one or more features that enable coupling of the collar 38 to the intermediate collar 32 and cap 33. The features may include, but are not limited to, protrusion and ridge engagements, interference fit engagements, additional materials such as joining materials (e.g., epoxy, adhesive, etc.) to form the engagements, and any combination thereof. As also shown, the collar 38 is structured to receive the shaft 34. In this regard, the shaft 34 extends through an opening in the collar 38 to enable reception through the opening in the adapter 53. As a result and when the sprinkler 10 is assembled, the shaft 34 is received in the adapter 53 and the collar 38 is engaged with the adapter 53 itself to couple the stem 14 to the collar 38 and the components coupled thereto. The collar 38 may remain stationary during use (like the stem 14), yet because of the intermediary collar 32, the trip collars 24 and 25 may be capable of relative rotation to each other, the collar 38, and in turn to the stem 14 as well.

An inner cap 33 (e.g., lid, cover, top, etc.) may be disposed at or near the vertical top of the sprinkler 10. The cap 33 may be coupled to the shaft 34 (e.g., stem, pole, etc.). The shaft 34 includes a coupling mechanism 35, which is shown as threads, may be structured to enable coupling of the stem 14 to the shaft 34. Thus, the coupling of the collar 38 and components coupled thereto to the stem 14 may include the following features: the adapter 53 itself engaging with an opening that matches or substantially matches the shape of the adapter 53 in the collar 38, reception of the shaft 34 in the opening of the adapter 53, and the coupling mechanism 35 that attaches the shaft 34 to the stem 14. In other configuration, more, less, or different coupling mechanisms may be used with all such variations intended to fall within the scope of the present disclosure.

Beneficially, the aforementioned coupling configuration is advantageous because if maintenance (e.g., cleaning) is desired for the inner portion of the stem 14 (i.e., the fluid passage 80), a user may de-couple the shaft 34 from the stem 14 via the coupling mechanism 35 and lift the components coupled to the collar 38 vertically upwards away from the stem 14 in order to access the fluid passage 80 (and the components therein, such as a filter if included). According to an alternate embodiment, the stem 14 may be manufactured to not be open at the top (i.e., proximate the trip collars 24, 25). Both variations are intended to fall within the scope of the present disclosure.

Still referring primarily to FIG. 3 and as mentioned above, the collar 38 includes a retainer, shown as a hook 36. As described herein and in one embodiment, the trip collars 24, 25 may be movable, slidable, or otherwise translatable parallel to the first axis 90 to selectively enable or disable interaction with the trip flanges 26 and 27 by the trip paddle 45. In this regard and as shown, a space is created between the ledge 29 and a bottom end 37 of the hook 36. As a result, the intermediary collar 32 may slide vertically upwards until the ledge 29 or another bottom portion of the intermediary collar 32 (or a different component) abuts or impacts the bottom end 37, which then stops or prevents further movement of the intermediary collar 32 upwards. In comparison, a top portion of the hook 36 may engage with the cap 28 and/or intermediary collar 32 to restrict or constrain downward movement of the intermediary collar 32 (e.g., towards the nozzle body 16).

As also shown, the first trip collar 24 includes a trip flange 26 (e.g., stop member, projection, etc.) while the second trip collar 25 includes a trip flange 27 (e.g., stop member, projection, etc.). The trip flange 26 may be of integral construction with the trip collar 24 or may be coupled to the trip collar 24. Similarly, the trip flange 27 may be of integral construction with the trip collar 25 or may be coupled to the trip collar 25. As shown, the trip flanges 26 and 27 extend radially outward from the trip collars 24 and 25, respectively, and are shaped as substantially rectangular prisms. However, in other embodiments, a variety of other shapes and configurations may be used (e.g., the trip flanges may not be solid bodies like shown, be square shaped to resemble a tab, etc.).

Because the first and second trip collars 24, 25 are rotatable about the primary axis 90 relative to each other, the trip flanges 26 and 27 are also rotatable about the primary axis 90 relative to each other. In this regard, the gap separating the trip flanges 26 and 27 may be variable. For example, if a relatively smaller range of rotation of the nozzle body 16 is desired, the user may rotate the first and second trip collars 24, 25 relatively close together. However, if a relatively large range of rotation of the nozzle body 16 is desired, the user may rotate the trip flanges 26 and 27 relatively further apart from each other. Thus, relative positioning of the trip flanges 26 and 27 to each other controls the range of rotation of the spray nozzle 18. In this regard and as shown, the trip flanges 26, 27 form part of the rotation limitation mechanism 100. As described herein, the trip flanges 26 and 27 may be structured to limit rotation of the nozzle body 16 and cause the nozzle body 16 to change rotation directions about the primary axis 90.

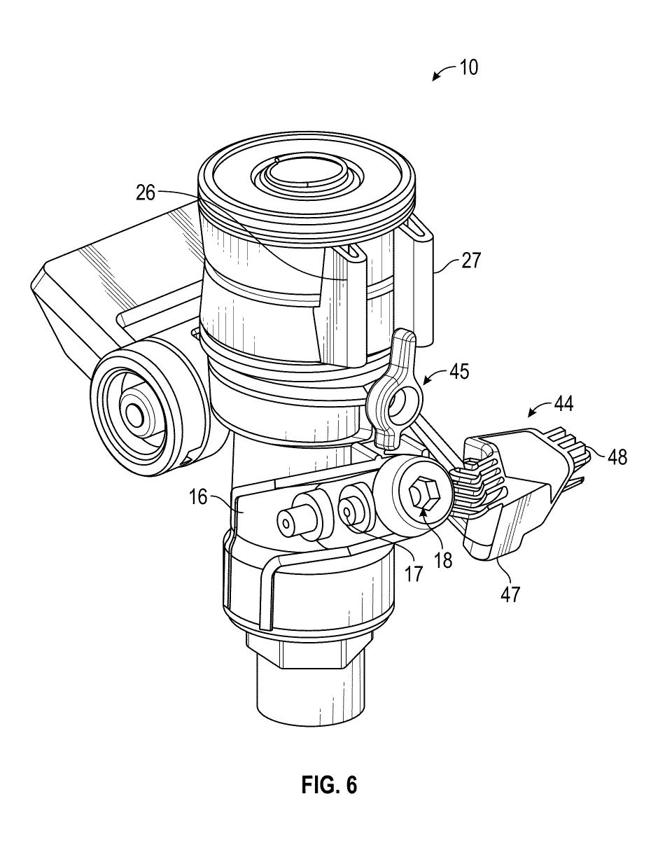

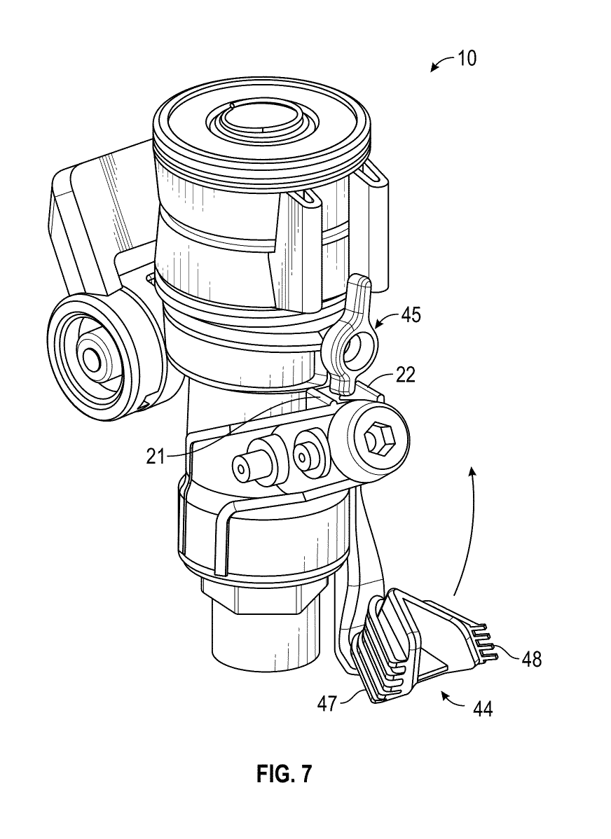

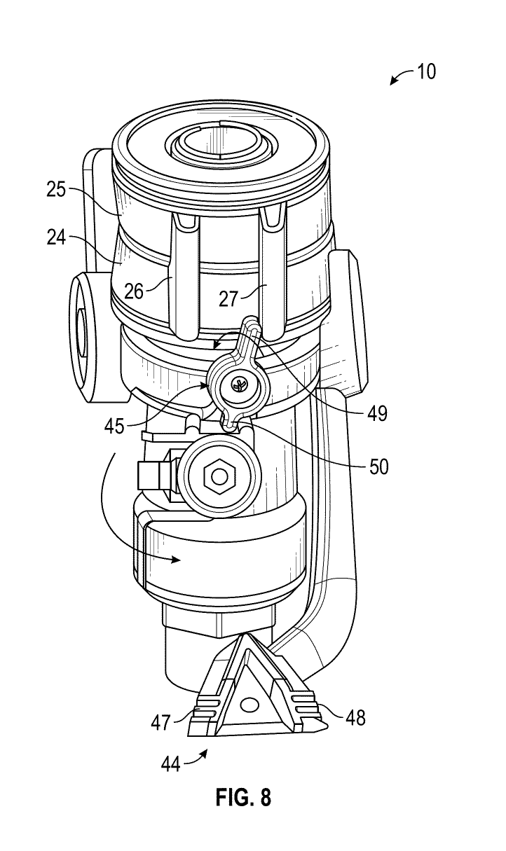

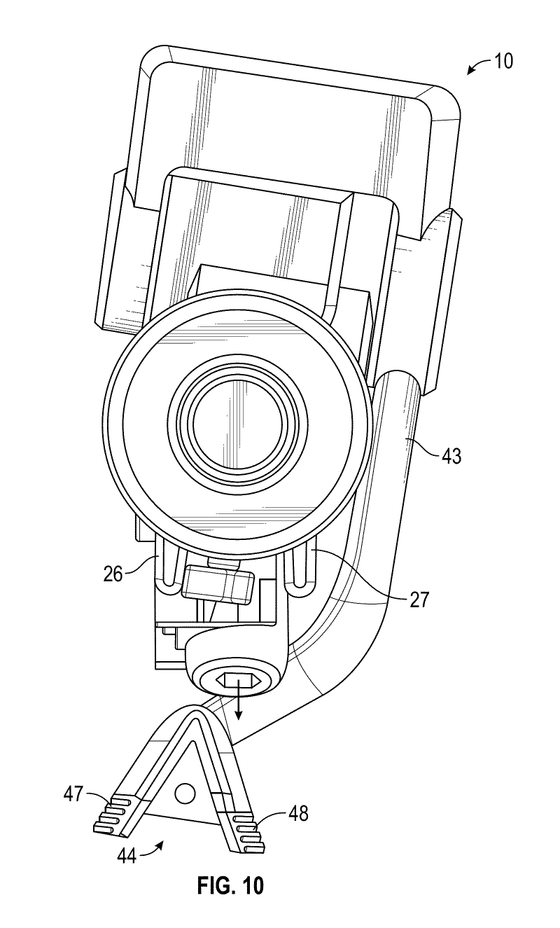

With the aforementioned structural components of the sprinkler 10 described above, operation of the sprinkler 10 with the rotation limitation mechanism 100 may be described as follows. For reference purposes, FIG. 6 depicts the swing arm 43 of the swing arm assembly 40 in the in configuration or up position, FIG. 7 depicts the arm 43 of the swing arm assembly 40 in the out or down configuration, FIG. 8 depicts a front view (i.e., facing the spray nozzle 18) of the sprinkler 10 in FIG. 5, FIG. 9 depicts the diffuser 44 of the swing arm assembly 40 in the right configuration, and FIG. 10 depicts the diffuser 44 of the swing arm assembly 40 in the left configuration. Accordingly referring now to FIGS. 6-10 in combination with FIGS. 1-5, operation of the sprinkler 10 may be described as follows.

As a precursor to operation of the sprinkler 10, the sprinkler 10 is fluidly connected to fluid source (e.g., a water spigot). A user may then rotate the first and second trip collars 24 and 25 to a desired trip flange 26 and 27 separation distance. The separation distance may correspond with anywhere between approximately zero (0) degrees of rotation permitted by the nozzle body 16 and approximately three-hundred and sixty (360) degrees of rotation about the primary axis 90. Once the desired rotation amount is set by arranging the position of the trip flanges 26 and 27, the fluid source may be turned on (e.g., allowed to flow to the sprinkler 10). Assuming the sprinkler 10 fluid flow control device (when implemented) is in a position that allows fluid to flow out the spray nozzle 18, operation of the sprinkler 10 may be described as follows.

When the stream of fluid is emitted from the spray nozzle 18 and the swing arm assembly 40 is in the in configuration, the fluid strikes, contacts, or otherwise engages with the diffuser 44. The fluid that contacts the diffuser 44 pushes or forces the diffuser 44 into the out configuration. However, due to the counter weight or another biasing element in the body 42 of the swing arm assembly 40, the diffuser 44 is biased back towards the in configuration. As a result, an oscillation is created by diffuser 44 where the diffuser and arm 43 rotate about the second axis 91 between the in and out configurations.

In addition to this oscillation, the impact of the fluid on the diffuser 44 also causes rotation of the diffuser 44 and nozzle body 16 about the primary axis 90. Thus, the diffuser 44 moves about the primary axis 90 and the secondary axis 91. In this regard and referring first to FIG. 6, fluid dispensed from the spray nozzle 18 is shown to impact only one or primarily only one side of the diffuser 44. In the configuration of FIG. 6, fluid impacts the first set of ridges 47. The upward trajectory of the fluid from the spray nozzle 18 pushes the diffuser 44 downward towards the out configuration (FIG. 7) and also pushes, impacts, forces, or otherwise moves the diffuser 44 (and the arm 43) to the right (counterclockwise as shown in the view point of FIG. 9). This counterclockwise movement of the swing arm 43 causes the swing arm collar 41 to also move counterclockwise in an amount that corresponds with the amount moved by the body 42. In one embodiment, this amount is relatively small or discrete, where relatively small or discrete means less than or equal to three (3) degrees about the primary axis 90. In another embodiment, a different amount may be characterized by each impact of the fluid to the diffuser 44. Because the swing arm collar 41 rotates, the trip paddle 45 also moves. As a result of the movement of the trip paddle 45, the first and second arms 49 and 50 also move. In one embodiment, the second arm 50 slides on the surface 23 of the nozzle body 16. In another embodiment, the second arm 50 hovers above the surface 23. In either instance, the trip paddle 45 may move counterclockwise about the first axis 90 in a coincident manner to the swing arm collar 41 and diffuser 44.

As mentioned above, the protrusions 55 of the swing arm collar 41 may engage with the grooves of collar 20. As a result, the nozzle body 16 may be engaged with the swing arm assembly 40. Therefore, when the swing arm collar 41 rotates, a force may be imparted by the protrusions of the collar 41 onto the collar 20. This rotational force may then cause the nozzle body 16 to also rotate. Therefore, the nozzle body 16 rotates in the same direction as the swing arm collar 41 about the primary axis 90 (and, in turn, the diffuser 44 as well). In one embodiment, the amount of rotation of the nozzle body 16 about the primary axis 90 may correspond or match the amount of rotation of the swing arm collar 41 (e.g., the relatively small amount described above). In another embodiment, the amount of rotation of the nozzle body 16 about the primary axis 90 may differ from that of the amount of rotation of the swing arm collar 41 by more than the relatively small amount described above.

With this in mind, the rotation limitation mechanism 100 may be described as follows. At some point during the rotational movement of the nozzle body 16 and swing arm collar 41 counterclockwise, the first arm 49 impacts, contacts, or otherwise engages with the second trip flange 27. This point in rotation corresponds with the prescribed rotational amount defined by the user (i.e., the placement of the trip flanges 26 and 27 at a desired rotational amount). As the fluid keeps impacting the first ridges 47 (i.e., the right configuration of FIG. 9), the swing arm collar 41 keeps getting pushed or rotated counterclockwise. At some point, the engagement of the first arm 49 is then pushed into being substantially parallel with the second trip flange 27 until, eventually, the first arm 49 is pushed counterclockwise about the third axis 93 (based on the view in FIG. 8). In this regard, the impact of the first arm 49 with the second trip flange 27 causes or eventually causes the first arm 49 to rotate counterclockwise about the third axis 93 (i.e., towards the first trip flange 26) (see FIG. 8) (i.e., a direction counter or opposite to the current rotational direction of the nozzle body 16). Concurrently or near concurrently, the second arm 50 may also rotate counterclockwise to push the second protrusion 22 and, in turn, the nozzle body 16 even further counterclockwise. This counterclockwise push may be relatively greater than the previous relatively small or discrete amounts of counterclockwise rotation of the nozzle body 16 about the primary axis 90. As a result, the relative position of the spray nozzle 18 and diffuser 44 may change, such that the spray nozzle 18 may emit a fluid stream that now impacts, contacts, or otherwise engages with the second set of ridges 48 (FIG. 10). This impact causes the diffuser 44 to move now clockwise about the primary axis 90 (based on the viewpoint in FIG. 10). In turn, the swing arm collar 41 moves or rotates in a corresponding clockwise direction about the primary axis 90. Due to the protrusion 55 and groove 52 engagement, the nozzle body 16 now also moves clockwise in a substantially corresponding amount about the primary axis 90. Similar to the operation described above, eventually, the first arm 49 impacts the first trip flange 26. The first arm 49 may then rotate clockwise about the third axis 92 (i.e., towards the second trip flange 27). As a result, the second arm 50 may push the first protrusion (and, in turn, the nozzle body 16) clockwise by a relatively greater amount than the previous rotation amount clockwise to cause the fluid stream to impact the first set of ridges 47 again. At this point, the process may repeat itself, such that the nozzle body 16 may rotate between the trip flanges 26 and 27.

Thus, the nozzle body 16 rotates between the trip flanges 26 and 27 to provide fluid at the range of rotation about the primary axis 90 that is defined by the separation distance of the trip flanges 26 and 27. Further, the arms of the trip paddle are structured to therefore move the nozzle body and cause, at least in part, a change of rotational direction of the nozzle body.

Additionally and as described herein above, the rotation amount of trip paddle 45 about the third axis 92 may be relatively greater than the rotation amount of the nozzle body 16 (and, in turn, the swing arm collar 41) about the primary axis 90. More particularly, the rotation amount of trip paddle 45 may be relatively greater than the discrete amount of rotation of the nozzle body 16 caused by each instance of the fluid impacting the diffuser (i.e., when the fluid impacts the diffuser in the in configuration, a discrete amount of rotation about the primary axis 90 results, which is less than the amount of rotation of trip paddle 45 about the third axis 92). As a result, when the trip paddle 45 rotates, the trip paddle 45 may force, push, or otherwise rotate the nozzle body 16 in the same direction but relatively further about the primary axis 90 than the nozzle body 16 was previously rotating about the primary axis 90 (i.e., the discrete rotational amount). As such, the emitted fluid may then impact the side of the diffuser 44 not or substantially not previously impacted before the switch to then cause the nozzle body 16 to switch rotation directions.

The rotation limitation mechanism 100 described above offers several advantages. First, the trip flanges 26 and 27 are disposed above the nozzle body 16 in contrast to current and conventional impact sprinklers. This positioning enables a user to relatively easy see, inspect, and control placement of the trip flanges 26 and 27 to, in turn, control the degree of rotation of the nozzle body 16. This may be appealing to consumers and increase the overall pleasantness of use. Second, the robust nature of the sprinkler 10 relative to current impact sprinklers may improve the performance of the sprinkler 10 over a longer period of time than conventional impact sprinklers. In this regard, conventional impact sprinklers typically have exposed springs that control rotation of the sprinkler head. In contrast, the sprinkler 10 of the present disclosure does not include such an exposed element that is otherwise subject to environmental degradation.

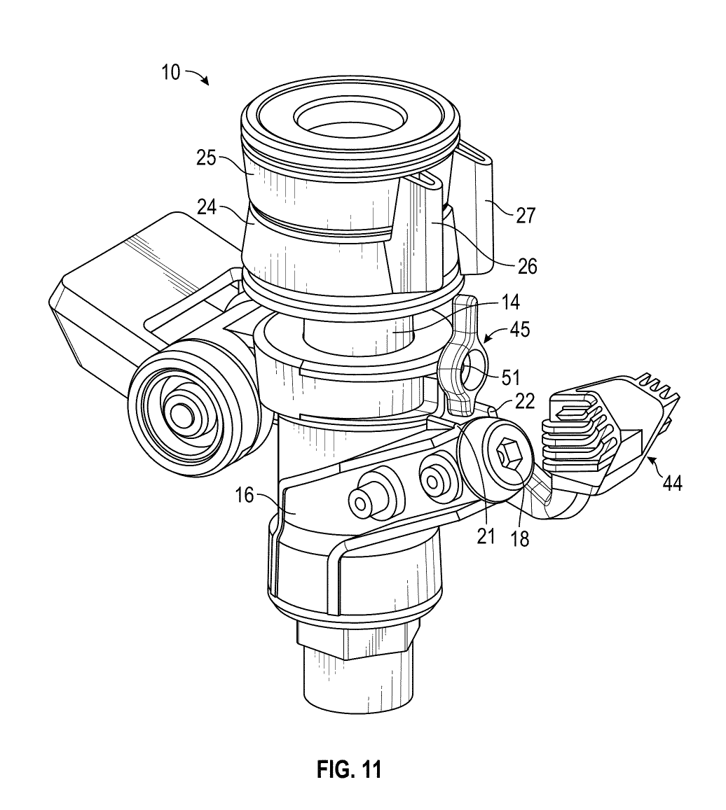

As mentioned herein above, in certain embodiments, the rotation limitation mechanism 100 may also include a disengagement mechanism that is structured to remove the ability to impart a limited rotation capability to the spray nozzle 18. In this regard, the spray nozzle 18 may then be permitted to rotate continuously clockwise or counterclockwise about the primary axis 90. This may be advantageous if the user desires a repeated three-hundred and sixty (360) degree fluid covering from the spray nozzle. While many different disengagement mechanisms may be included with the rotation limitation mechanism 100, various examples are shown herein with respect to FIGS. 11-14. Because these disengagement mechanisms may be used with the sprinkler 10 of FIGS. 1-10, similar reference numbers are used in FIGS. 11-14 as with FIGS. 1-10.

Accordingly referring first to FIG. 11, a first type of disengagement mechanism 150 is shown according to an example embodiment. This disengagement mechanism 150 is characterized by the trip flanges 26 and 27 being slidable, translatable, or otherwise movable in a parallel or substantially parallel direction relative to the primary axis 90 (i.e., vertically upward and downward). In this regard and as mentioned above with respect to FIG. 3, the intermediary collar 32 may have a ledge 29 that is at a distance (in the vertical direction) from a bottom end 37 of the hook 36. As a result, a user may move the first and second trip collars 24 and 25 that separation distance in an upward direction (i.e., towards the bottom end 37) before the ledge 29 or other bottom piece coupled to the trip collars 24 and 25 impacts the bottom end 37. The separation distance may be any distance that moves the trip flanges 26 and 27 out of a position where they may be impacted by the trip paddle 45 arms. If the user desires to limit rotation of the sprinkler nozzle 18, then the user may simply push the cap 28 downwards (e.g., towards the base 12) to place the trip flanges 26 and 27 back into a position that may engage with the trip paddle 45. Beneficially, impacting the hook 36 prevents the trip collars 24 and 25 from being slidably removed from the sprinkler 10. Simply pushing or pulling the cap 28 to place the trip flanges 27, 28 into and out of a position for utilizing the rotation limitation mechanism 100 may be appealing to users who desire quick and easy ways to engage or disengage the rotation limitation mechanism 100.

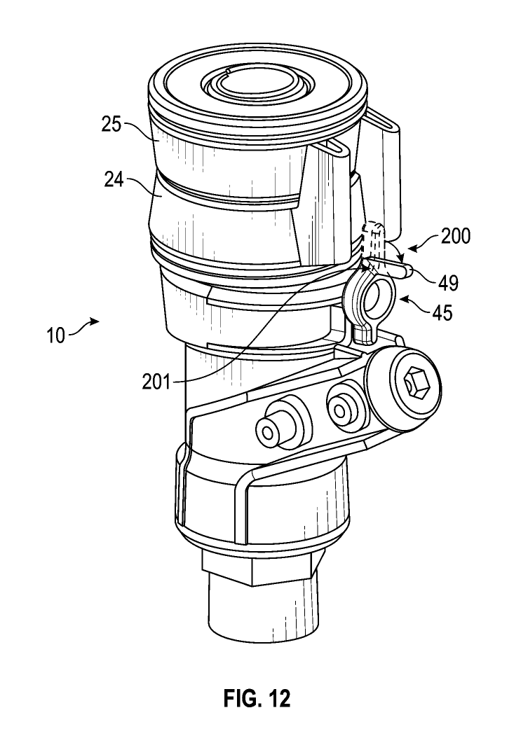

Referring now to FIG. 12, a second type of disengagement mechanism 200 is shown according to an example embodiment. The second type of disengagement mechanism 200 is characterized by a movable first arm 49. In particular and as shown, the first arm 49 is pivotably coupled to the trip paddle 45 by a joint 201. The joint 201 may include a hinge, a spring (e.g., a torsion spring), a pin, and/or any other type of pivot mechanism that allows the first arm 49 to rotate towards trip collars 24 and 25 (and trip flanges 26 and 27) and away from the trip collars 24 and 25. More particularly, the first arm 49 is rotatable from a first position to a second position and vice versa. In the first position, the first arm 49 is capable of engaging with the trip flanges 26 and 27. In the second position, the first arm 49 is moved out of a position from being capable of engaging with the trip flanges 26 and 27. In certain arrangements, a retention or holding mechanism may be used to hold the first arm 49 in the first and/or second positions. For example, the first arm 49 may be constructed from a magnetic material and a magnetic material may be disposed on the trip collar 24 as well as, e.g., the second arm 50 while a pin used to couple the first arm 49 to the trip paddle 45. Thus, a magnetic force may retain or hold the first arm 49 in either the first or second positions. As another example, weight of the first arm 49 may be used as the retention mechanism (e.g., the first arm 49 may rotate beyond ninety degrees towards the trip flanges 26 and 27 such that the weight holds the arm 49 in the first position while the weight holds the arm 49 in the second position). Thus, via the disengagement mechanism 200, the rotation limitation mechanism 100 may be engaged when the first arm 49 is in the first position or disengaged when the first arm 49 is in the second position.

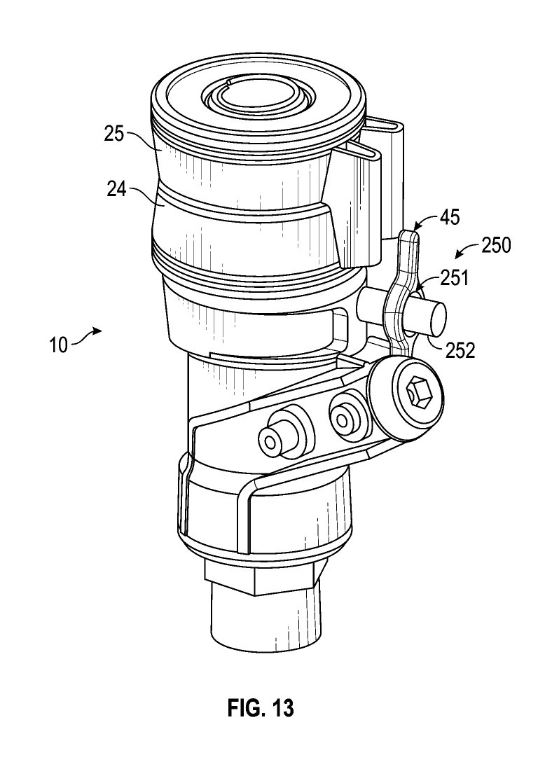

Referring now to FIG. 13, a third type of disengagement mechanism 250 is shown according to an example embodiment. This disengagement mechanism 250 is characterized by the trip paddle 45 being slidable, translatable, or otherwise movable along the third axis 93 (i.e., parallel or substantially parallel to) to selectively allow the trip paddle 45 to engage with the trip flanges 26 and 27 of the sprinkler 10. In this example, the trip paddle 45 defines an opening 251 while a pin 251 (e.g., shaft, rod, pole, etc.) that is coupled to the swing arm collar 41. The opening 251 is sized to enable reception of the pin 251. In operation, a user may slide the trip paddle 45 between a first and second position. In the first position, the trip paddle 45 is moved into a location that enables the first arm 49 to engage with the trip flanges 26 and 27. In the second position, the trip paddle 45 is slid or moved to a location where the trip paddle 45 cannot engage with the trip flanges 26 and 27. In some instances, the trip paddle 45 may be taken off of the pin 251 entirely. In other instances, a retainer or retention mechanism may be used to prevent the complete removal of the trip paddle 45 (e.g., a raised edge, etc.). Thus, via the disengagement mechanism 250, the rotation limitation mechanism 100 may be engaged when the first arm 49 is in the first position or disengaged when the first arm 49 is in the second position.

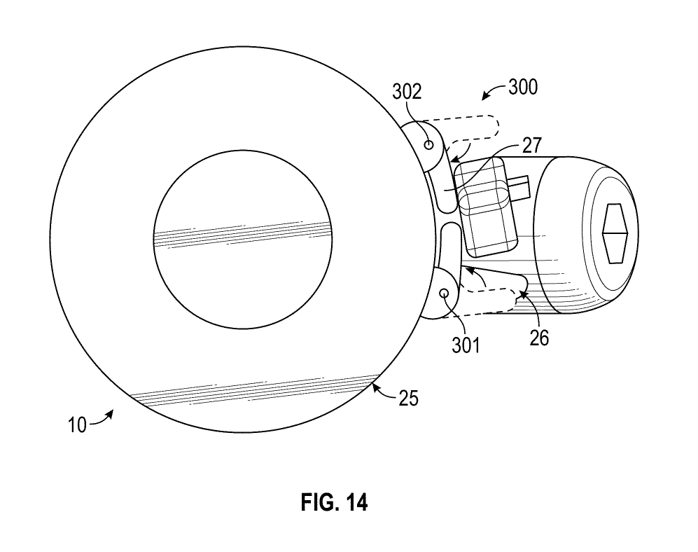

Referring now to FIG. 14, a fourth type of disengagement mechanism 300 is shown according to an example embodiment. This disengagement mechanism 300 is characterized by movable trip flanges 26 and 27 into and out of a first and a second position. In the first position, the trip flanges 26 and/or 27 are moved into a position where the trip flanges 26 and/or 27 may engage with the first arm 49 of the trip paddle 45. In the second position, the trip flanges 26 and/or 27 are moved into a position where the trip flanges 26 and/or 27 cannot engage with the first arm 49. More particularly and as shown, the trip flange 26 is rotatably coupled to the trip collar 24 by a joint 301. As shown, the trip flange 27 is rotatably coupled to the trip collar 25 by a joint 302. The joints 301 and 302 may include a hinge, a spring (e.g., a torsion spring), and any other type of pivot mechanism that allows the trip flanges 26 and 27 to rotate towards trip collars 24 and 25 (the second position) and away from the trip collars 24 and 25 (first position). In this regard, in the first position, the trip flanges 26 and/or 27 are spaced apart from the trip collars 24 and 25 while in the second position, the trip flanges 26 and/or 27 are positioned proximate the trip collars 24 and 25 (e.g., close to, potentially in contact with, etc.). Thus, via the disengagement mechanism 300, the rotation limitation mechanism 100 may be engaged when the first arm 49 is in the first position or disengaged when the first arm 49 is in the second position.

It should be understood that the aforementioned described disengagement mechanisms are not meant to be limiting. In this regard, different disengagement mechanisms may also be utilized with the rotation limitation mechanism 100 of the present disclosure without departing from the scope of the present disclosure. For example, the trip flanges may be magnetically coupled to the trip collars. As such, a user may simply overcome the magnetic force to remove the trip flanges from the trip collars. As another example, a fastener may be used to couple the trip flanges to the trip collars (e.g., a screw). As such, a user may simply remove the fastener to de-couple the trip flanges from the trip collars. Thus, many types of disengagement mechanisms are contemplated by the present disclosure with all such variations intended to fall within the scope of the present disclosure.

It should also be understood that while the present disclosure describes each disengagement mechanism separately, in certain embodiments, more than one disengagement mechanism may be utilized together. For example, the first and third disengagement mechanisms may be implemented with one impact sprinkler. Further and according to an alternate embodiment, no disengagement mechanism may be used. Thus, many different variations are possible with all such variations intended to fall within the scope of the present disclosure.

It should further be understood that the nozzle body 16, one or more components of the swing arm assembly 40, stem 14, and any other component of the sprinkler 10 may be constructed as a unitary body (e.g., a one-piece component) or as an assembly of components. Further, these components may be constructed from any suitable material including, but not limited to, a plastic material, a metal or metal alloy material, and/or any combination therewith. For example, the use of engineered plastics may provide a preferred combination of light weight and strength. According to other embodiments, a number of alternate materials can be used to produce the sprinkler: cast or machined aluminum or brass could be utilized in the construction, a variety of steels, various composites, and/or any combination thereof. Thus, those of ordinary skill in the art will appreciate the high configurability of the components.

It is important to note that the construction and arrangement of the elements of the irrigation device, shown as an impact sprinkler, with a rotation limitation mechanism is illustrative only. Although only a few embodiments have been described in detail in this disclosure, those skilled in the art who review this disclosure will readily appreciate that many modifications are possible without materially departing from the novel teachings and advantages of the subject matter recited.

Further, all such modifications are intended to be included within the scope of the present disclosure. Other substitutions, modifications, changes and omissions may be made in the design, operating conditions and arrangement of the preferred and other exemplary embodiments without departing from the spirit of the present disclosure possible (e.g., variations in sizes, dimensions, structures, shapes and proportions of the various elements, values of parameters, mounting arrangements, use of materials, colors, orientations, etc.). Thus, one of ordinary skill in the art will appreciate that many modifications, alterations, or changes may be imparted into the tools disclosed herein without departing from the spirit and scope of the present disclosure.

For the purpose of this disclosure, the term “coupled” or other similar terms, such as “attached,” means the joining of two members directly or indirectly to one another. Such joining may be achieved directly with the two members or the two members and any additional intermediate members being attached to one another and the two members. For example and for the purposes of this disclosure, component A may be referred to as being coupled to component B even if component C is an intermediary, such that component A is not directly connected to component B. On the other hand and for the purposes of this disclosure, component A may be considered coupled to component B if component A is directly connected to component B (e.g., no intermediary). Such joining may be stationary or moveable in nature. Such joining may be permanent in nature or may be removable or releasable in nature.

The order or sequence of any process or method steps may be varied or re-sequenced according to alternative embodiments. In the claims, any means-plus-function clause is intended to cover the structures described herein as performing the recited function and not only structural equivalents but also equivalent structures. Other substitutions, modifications, changes and omissions may be made in the design, operating configuration and arrangement of the preferred and other exemplary embodiments without departing from the spirit of the present disclosure as expressed in the appended claims.

What is claimed:

1. An impact sprinkler, comprising:
a stem;
a first trip collar rotatably coupled to the stem, the first trip collar including a first trip flange;
a second trip collar rotatably coupled to the stem, the second trip collar including a second trip flange;
a nozzle body including a spray nozzle structured to emit a fluid stream, the nozzle body rotatably coupled to the stem; and
a base coupled to an end of the stem opposite an end of the stem where the first and second trip collars are positioned such that the nozzle body is an intermediary between the base and the first and second trip collars.

2. The impact sprinkler of claim 1, further comprising more than one seal structured to rotatably couple the nozzle body to the stem.

3. The impact sprinkler of claim 2, wherein the more than one seal includes a first stem seal and a second stem seal.

4. The impact sprinkler of claim 3, wherein the first stem seal is proximate to the first and second trip collars while the second steam seal is proximate to the base.

5. The impact sprinkler of claim 3, wherein the first and second steam seals include threads.

6. The impact sprinkler of claim 3, wherein the first and second stem seals include a gasket structured to aid creation of a fluid tight seal between the nozzle body and the stem.

7. The impact sprinkler of claim 3, wherein the stem defines a fluid outlet port, wherein the fluid outlet port is disposed between the first and second steam seals.

8. An impact sprinkler, comprising:
a stem including a first stem seal and a second steam seal, wherein the stem defines a fluid passage;
a nozzle body including a spray nozzle structured to emit fluid received from the fluid passage, the nozzle body rotatably coupled to the stem by the first and second steam seals;
a first trip flange rotatably coupled to the stem; and
a second trip flange rotatably coupled to the stem
wherein the first and second trip flanges are structured to control, at least in part, a rotational direction and a rotational amount of the nozzle body relative to the stem.

9. The impact sprinkler of claim 8, wherein the first and second trip flanges are positioned vertically above the nozzle body and the fluid passage.

10. The impact sprinkler of claim 8, wherein the nozzle body is structured to rotate about the stem based, at least in part, on the emitted fluid.

11. The impact sprinkler of claim 8, wherein the first and second steam seals include threads.

12. The impact sprinkler of claim 8, wherein the first and second stem seals include a gasket structured to aid creation of a fluid tight seal between the nozzle body and the stem.

13. The impact sprinkler of claim 8, wherein the first and second trip flanges extend radially outward relative to an axis of rotation of the nozzle body.

14. The impact sprinkler of claim 8, wherein the first and second trip flanges are rotatable relative to each other to control the rotational amount of the nozzle body.

15. The impact sprinkler of claim 8, wherein the spray nozzle is disposed at an angle relative to the stem.

16. The impact sprinkler of claim 8, wherein the stem defines a fluid outlet port fluidly coupled to the fluid passage, wherein the fluid outlet port is structured to provide fluid in the fluid passage to the nozzle body.

17. The impact sprinkler of claim 16, wherein the fluid outlet port is positioned between the first and second stem seals.

18. An impact sprinkler, comprising:
a stem including a first stem seal and a second steam seal, wherein the stem defines a fluid passage and a fluid outlet port;
a first trip collar rotatably coupled to the stem, the first trip collar including a first trip flange;
a second trip collar rotatably coupled to the stem, the second trip collar including a second trip flange; and
a nozzle body including a spray nozzle structured to emit a fluid stream, the nozzle body rotatably coupled to the stem by the first and second stem seals;
wherein the first and second trip collars are distal from the fluid passage of the stem; and
wherein the fluid outlet port is disposed between the first and second stem seals.

19. The impact sprinkler of claim 18, further comprising a base, wherein the base is coupled to an end of the stem opposite an end of the stem where the first and second trip collars are positioned such that the nozzle body is an intermediary between the base and the first and second trip collars.

20. The impact sprinkler of claim 18, wherein the spray nozzle is disposed at an angle relative to the stem.
